(19) United States
(12) Patent Application Publication
(10) Pub. No.: US 2017/0311369 A1
(43) Pub. Date: Oct. 26, 2017

(54) TRACKING AREA UPDATE ENHANCEMENT IN DUAL CONNECTIVITY

(71) Applicant: Nokia Solutions and Networks Oy, Espoo (FI)

(72) Inventors: Tsunehiko CHIBA, Saitama (JP); Srinivasan SELVAGANAPATHY, Bangalore (IN); Xiang XU, Nanjing (CN)

(73) Assignee: Nokia Solutions and Networks Oy, Espoo (FI)

(21) Appl. No.: 15/517,403

(22) PCT Filed: Oct. 23, 2014
(86) PCT No.: PCT/EP2014/072719

§ 371 Date: Apr. 6, 2017

(51) Int. Cl. H04W 76/02; H04W 64/00

(52) U.S. Cl. CPC H04W 76/025; H04W 64/003

(57) ABSTRACT

It is provided a method, comprising checking if a terminal connected to an apparatus performing the method is additionally to be connected to a secondary base station in a dual connectivity; providing provide, if the terminal is to be connected to the secondary base station in the dual connectivity, a secondary tracking area information of the secondary base station to the terminal; informing a management entity about the secondary tracking area information related to the terminal.

### FIELD OF THE INVENTION

The present invention relates to an apparatus, a method, and a computer program product related to mobile communication. More particularly, the present invention relates to an apparatus, a method, and a computer program product related to dual connectivity.

### BACKGROUND OF THE INVENTION

### Abbreviations

3G Third Generation
3GPP Third Generation Partnership Project
Ack Acknowledge
C-plane Control plane
CS Circuit Switched
eNB evolved NodeB
LA Location Area
LAC Location Area Code
LTE Long Term Evolution
LTE-A LTE Advanced
MCG Master Cell Group
MeNB Master eNB
MME Mobility Management Entity
NAS Non-Access Stratum
O&M Operation & Maintenance
PCell Primary Cell
PSCell Primary SCell
PUCCH Physical Uplink Control Channel
RAN Radio Access Network
RRC Radio Resource Control
SCell Secondary Cell
SCG Secondary Cell Group
SeNB Secondary eNB
S-GW Serving Gateway
SI Study Item
SIB System Information Block
TA Tracking Area
TAC Tracking Area Code
TAI Tracking Area Information
TAU Tracking Area Update
TR Technical Report
UE User Equipment
U-plane User plane
UMTS Universal Mobile Telecommunications System
WI Work Item
Wi-Fi Wireless Fidelity, e.g. defined by IEEE802.11 specifications and/or certified by Wi-Fi Alliance

3GPP RAN2 and RAN3 had worked on Release 12 Small Cell Enhancement SI. The outcome of the SI was captured in TR36.842 v1.0.0 and completed at RAN#63 plenary. 3GPP RAN2 and RAN3 have been working on Dual Connectivity WI (RP-132069).

In dual connectivity, UE is simultaneously connected with MeNB and SeNB, and control plane (RRC) for both MeNB and SeNB will be located in MeNB. There is one PCell associated to MeNB, and there is one PSCell associated to the SeNB and there may be a group of SCells in SeNB. One SCell is a PSCell which carries PUCCH, while other SCells do not carry PUCCH. MeNB may have one or more SCells, too, in addition to PCell. The RRC control plane for the UE is located in MeNB and not in SeNB. In particular, MeNB acts as mobility anchor towards the core network. MeNB is changed only at handover, while SeNB may be added or released depending on the needs as determined by MeNB. SeNB provides additional radio resources to the UE.

MeNB is sometimes used synonymously with PCell, and SeNB is sometimes used synonymously with SCell, if not otherwise indicated or made clear from the context. The group of the serving cells associated with the MeNB is named MCG, and the group of the serving cells associated with an SeNB is named SCG.

Dual connectivity is a mode of operation of a UE in RRC_CONNECTED state, configured with a Master Cell Group (MCG) and a Secondary Cell Group (SCG). FIG. 1 and FIG. 2 show the C-plane and U-plane architecture for dual connectivity, respectively.

As may be seen from FIG. 1, MeNB 1 exchanges control information with MME 3 via S1-MME interface 1003 and with SeNB 2 via X2-C interface 1002. SeNB 2 and MME 3 do not exchange directly control information for a terminal in dual connectivity.

On the other side, as may be seen from FIG. 2, in dual connectivity, there are three types of bearer:
For MCG bearers, the MeNB 1 is U-plane connected to the S-GW 4 via S1-U interface 1014, the SeNB 2 is not involved in the transport of user plane data.
For split bearers, the MeNB 1 is U-plane connected to the S-GW 4 via S1-U interface 1014 and in addition, the MeNB 1 and the SeNB 2 are interconnected via X2-U interface 1012.
For SCG bearers, the SeNB 2 is directly connected with the S-GW 4 via S1-U interface 1024.

Paging requests are transmitted by all cells of a tracking area, i.e. a tracking area is a set of cells. Tracking areas can be grouped into lists of tracking areas (TA lists), which are configured on the UE. Herein, TA and TA list may be used synonymously, if not stated otherwise or clear from the context. I.e., a TA list may comprise only one TA or more than one TA.

Tracking area updates are performed periodically or when the UE moves to a tracking area that is not included in its TA list. MME assigns the TA (or TA-list) to UE as part of attach procedure or Tracking area update procedure. The tracking area and tracking area list to be assigned to UE is based on the current serving cell of the UE. Operator configures the table which maps the tracking area against LTE Cells. TAU is performed in RRC connected mode. TAU may also be performed in idle mode periodically and when UE reselects a new cell whose TA is different from the currently stored TA. In this case, TAU may require to set up a RRC connection first.

When a network is deployed with macro cells and small cells together, the policy at MME for TA assignment for macro cells and small cells would be based on different schemes. For example:
If UE is in a macro cell, scheme TA1 is used; and
If UE is in a small cell, scheme TA2 is used.

Based on this policy, if a UE registers or tracking area update is performed from any macro cell, it will assign only TA according to the scheme (TA1) for macro-cells. That is, TA1 comprises macro-cells only. In the same way, if the registration or TAU is performed from any small-cell MME will assign the TA according to the scheme (TA2) for small cells. Correspondingly, TA2 comprises small cells only.

With above policy, at any point of time, TA (or TA list) assigned to UE will include either macro-TA or small-cell TA. This configuration ensures that the paging load towards small cells will corresponds to the camped UEs under small cells only.

To summarize, in network with macro and small-cell deployed together the recommended configuration assigns TA according to different tracking area schemes for macro cells and small cells. This configuration minimizes the paging load towards small cells.

A discussion on TAU in dual connectivity mode was conducted in 3GPP SA2 which raised a potential benefit during system analysis (see S2-140537), however no solution has been provided so far.

### SUMMARY OF THE INVENTION

It is an object of the present invention to improve the prior art.

According to a first aspect of the invention, there is provided an apparatus, comprising checking means adapted to check if a terminal connected to the apparatus is additionally to be connected to a secondary base station in a dual connectivity; providing means adapted to provide, if the terminal is to be connected to the secondary base station in the dual connectivity, a secondary tracking area information of the secondary base station to the terminal; informing means adapted to inform a management entity about the secondary tracking area information related to the terminal.

According to a second aspect of the invention, there is provided an apparatus, comprising checking means adapted to check if a secondary tracking area information of a secondary base station is received; providing means adapted to provide, if the secondary tracking area information is received, the secondary tracking area information to a terminal; informing means adapted to inform a management entity about the secondary tracking area information related to the terminal.

The apparatus according to each of the first and second aspects may further comprise monitoring means adapted to monitor if a tracking area update request is received from the terminal after the secondary tracking area information was provided to the terminal; inhibiting means adapted to inhibit the informing means from informing the management entity if the tracking area update request is not received.

The apparatus according to each of the first and second aspects may further comprise comparing means adapted to compare the secondary tracking area information with a master tracking area of the apparatus; inhibiting means adapted to inhibit the providing means from providing the secondary tracking area information if the master tracking area information comprises the secondary tracking area information.

In the apparatus according to each of the first and second aspects, the secondary tracking area information is received from the secondary base station in response to an addition request for the terminal, or during a setup procedure of an interface to the secondary base station.

According to a third aspect of the invention, there is provided an apparatus, comprising monitoring means adapted to monitor if a secondary tracking area information of a secondary base station is received, wherein the apparatus is connected in a dual connectivity to a master base station and the secondary base station; updating means adapted to update, if the secondary tracking information is received, a tracking area list stored in the apparatus by the secondary tracking area information.

The apparatus may further comprise requesting means adapted to request a tracking area update if the secondary tracking area information is received; inhibiting means adapted to inhibit the updating means from updating the tracking area list until a response to the tracking area update request is received, wherein the response comprises the secondary tracking area information.

According to a fourth aspect of the invention, there is provided an apparatus, comprising monitoring means adapted to monitor if an information is received from a master base station on a secondary tracking area information related to a terminal; updating means adapted to update, if the information is received, a tracking area list for the terminal stored by the apparatus by including the secondary tracking area information.

The information may be comprised in an uplink message informing additionally on a tracking area update request of the terminal; and the apparatus may further comprise responding means adapted to respond to the uplink message by a downlink message comprising the updated tracking area list.

The updated tracking area list may comprise the secondary tracking area information only, or the updated tracking area list may comprise the secondary tracking area information in addition to tracking area information comprised by the tracking area list before the updating by the updating means.

The updated tracking area list may comprise the secondary tracking area information indicating a tracking area of a secondary base station, and a master tracking area information indicating a tracking area of a master base station.

The apparatus may further comprise identifying means adapted to identify, based on the secondary tracking area information, a secondary local area code, wherein the secondary local area code is related to a location of the secondary base station; providing means adapted to provide, if the information about the tracking area update request is received, the secondary local area code to the master base station.

The apparatus may further comprise comparing means adapted to compare the secondary local area code with a master local area code related to a location of the master base station, inhibiting means adapted to inhibit the providing means from providing the secondary local are code if the secondary local area code and the master local area code are the same.

The information may be comprised in an uplink message comprising at least one of a radio access bearer modification request, a path switch request, and a handover request acknowledge.

According to a fifth aspect of the invention, there is provided an apparatus, comprising monitoring means adapted to monitor if a request to add the apparatus for dual connectivity of a terminal with a master base station and the apparatus is received from the master base station; providing means adapted to provide, if the request is received, a secondary tracking area information indicating a tracking area of the apparatus in response to the request.

According to a sixth aspect of the invention, there is provided an apparatus, comprising checking means adapted to check if an interface between the apparatus and a master base station is being set up; informing means adapted to inform the master base station on a tracking area of the apparatus when the interface is set up.

According to a seventh aspect of the invention, there is provided an apparatus, comprising supervising means adapted to supervise if a tracking area information of the apparatus is modified to a new tracking area information; informing means adapted to inform a master base station about the new tracking area information.

According to a eighth aspect of the invention, there is provided an apparatus, comprising checking circuit configured to check if a terminal connected to the apparatus is additionally to be connected to a secondary base station in a dual connectivity; providing circuit configured to provide, if the terminal is to be connected to the secondary base station in the dual connectivity, a secondary tracking area information of the secondary base station to the terminal; informing circuit configured to inform a management entity about the secondary tracking area information related to the terminal.

According to a ninth aspect of the invention, there is provided an apparatus, comprising checking circuit configured to check if a secondary tracking area information of a secondary base station is received; providing circuit configured to provide, if the secondary tracking area information is received, the secondary tracking area information to a terminal; informing circuit configured to inform a management entity about the secondary tracking area information related to the terminal.

The apparatus according to each of the eighth and ninth aspects may further comprise monitoring circuit configured to monitor if a tracking area update request is received from the terminal after the secondary tracking area information was provided to the terminal; inhibiting circuit configured to inhibit the informing circuit from informing the management entity if the tracking area update request is not received.

The apparatus according to each of the eighth and ninth aspects may further comprise comparing circuit configured to compare the secondary tracking area information with a master tracking area of the apparatus; inhibiting circuit configured to inhibit the providing circuit from providing the secondary tracking area information if the master tracking area information comprises the secondary tracking area information.

In the apparatus according to each of the eighth and ninth aspects, the secondary tracking area information is received from the secondary base station in response to an addition request for the terminal, or during a setup procedure of an interface to the secondary base station.

According to a tenth aspect of the invention, there is provided an apparatus, comprising monitoring circuit configured to monitor if a secondary tracking area information of a secondary base station is received, wherein the apparatus is connected in a dual connectivity to a master base station and the secondary base station; updating circuit configured to update, if the secondary tracking information is received, a tracking area list stored in the apparatus by the secondary tracking area information.

The apparatus may further comprise requesting circuit configured to request a tracking area update if the secondary tracking area information is received; inhibiting circuit configured to inhibit the updating circuit from updating the tracking area list until a response to the tracking area update request is received, wherein the response comprises the secondary tracking area information.

According to a eleventh aspect of the invention, there is provided an apparatus, comprising monitoring circuit configured to monitor if an information is received from a master base station on a secondary tracking area information related to a terminal; updating circuit configured to update, if the information is received, a tracking area list for the terminal stored by the apparatus by including the secondary tracking area information.

The information may be comprised in an uplink message informing additionally on a tracking area update request of the terminal; and the apparatus may further comprise responding circuit configured to respond to the uplink message by a downlink message comprising the updated tracking area list.

The updated tracking area list may comprise the secondary tracking area information only, or the updated tracking area list may comprise the secondary tracking area information in addition to tracking area information comprised by the tracking area list before the updating by the updating circuit.

The updated tracking area list may comprise the secondary tracking area information indicating a tracking area of a secondary base station, and a master tracking area information indicating a tracking area of a master base station.

The apparatus may further comprise identifying circuit configured to identify, based on the secondary tracking area information, a secondary local area code, wherein the secondary local area code is related to a location of the secondary base station; providing circuit configured to provide, if the information about the tracking area update request is received, the secondary local area code to the master base station.

The apparatus may further comprise comparing circuit configured to compare the secondary local area code with a master local area code related to a location of the master base station, inhibiting circuit configured to inhibit the providing circuit from providing the secondary local are code if the secondary local area code and the master local area code are the same.

The information may be comprised in an uplink message comprising at least one of a radio access bearer modification request, a path switch request, and a handover request acknowledge.

According to a twelfth aspect of the invention, there is provided an apparatus, comprising monitoring circuit configured to monitor if a request to add the apparatus for dual connectivity of a terminal with a master base station and the apparatus is received from the master base station; providing circuit configured to provide, if the request is received, a secondary tracking area information indicating a tracking area of the apparatus in response to the request.

According to a thirteenth aspect of the invention, there is provided an apparatus, comprising checking circuit configured to check if an interface between the apparatus and a master base station is being set up; informing circuit configured to inform the master base station on a tracking area of the apparatus when the interface is set up.

According to a fourteenth aspect of the invention, there is provided an apparatus, comprising supervising circuit configured to supervise if a tracking area information of the apparatus is modified to a new tracking area information; informing circuit configured to inform a master base station about the new tracking area information.

According to a fifteenth aspect of the invention, there is provided a method, comprising checking if a terminal connected to an apparatus performing the method is additionally to be connected to a secondary base station in a dual connectivity; providing provide, if the terminal is to be connected to the secondary base station in the dual connectivity, a secondary tracking area information of the secondary base station to the terminal; informing a management entity about the secondary tracking area information related to the terminal.

According to a sixteenth aspect of the invention, there is provided a method, comprising checking if a secondary tracking area information of a secondary base station is received; providing, if the secondary tracking area information is received, the secondary tracking area information to a terminal; informing a management entity about the secondary tracking area information related to the terminal.

The method according to each of the fifteenth and sixteenth aspects may further comprise monitoring if a tracking area update request is received from the terminal after the secondary tracking area information was provided to the terminal; inhibiting that the management entity is informed about the secondary tracking area information if the tracking area update request is not received.

The method according to each of the fifteenth and sixteenth aspects may further comprise comparing the secondary tracking area information with a master tracking area of an apparatus performing the method; inhibiting that the secondary tracking area information is provided to the terminal if the master tracking area information comprises the secondary tracking area information.

According to each of the fifteenth and sixteenth aspects, the secondary tracking area information may be received from the secondary base station in response to an addition request for the terminal, or during a setup procedure of an interface to the secondary base station.

According to a seventeenth aspect of the invention, there is provided a method, comprising monitoring if a secondary tracking area information of a secondary base station is received, wherein an apparatus performing the method is connected in a dual connectivity to a master base station and the secondary base station; updating, if the secondary tracking information is received, a tracking area list stored in the apparatus by the secondary tracking area information.

The method may further comprise requesting a tracking area update if the secondary tracking area information is received; inhibiting that the tracking area list is updated until a response to the tracking area update request is received, wherein the response comprises the secondary tracking area information.

According to an eighteenth aspect of the invention, there is provided a method, comprising monitoring if an information is received from a master base station on a secondary tracking area information related to a terminal; updating, if the information is received, a tracking area list for the terminal stored by an apparatus performing the method by including the secondary tracking area information.

The information may be comprised in an uplink message informing additionally on a tracking area update request of the terminal; and the method may further comprise responding to the uplink message by a downlink message comprising the updated tracking area list.

The updated tracking area list may comprise the secondary tracking area information only, or the updated tracking area list may comprise the secondary tracking area information in addition to tracking area information comprised by the tracking area list before the updating of the tracking area list.

The updated tracking area list may comprise the secondary tracking area information indicating a tracking area of a secondary base station, and a master tracking area information indicating a tracking area of a master base station.

The method may further comprise identifying, based on the secondary tracking area information, a secondary local area code, wherein the secondary local area code is related to a location of the secondary base station; providing, if the information about the tracking area update request is received, the secondary local area code to the master base station.

The method may further comprise comparing the secondary local area code with a master local area code related to a location of the master base station, inhibiting that the secondary local are code is provided if the secondary local area code and the master local area code are the same.

The information may be comprised in an uplink message comprising at least one of a radio access bearer modification request, a path switch request, and a handover request acknowledge.

According to a nineteenth aspect of the invention, there is provided a method, comprising monitoring if a request to add an apparatus performing the method for dual connectivity of a terminal with a master base station and the apparatus is received from the master base station; providing, if the request is received, a secondary tracking area information indicating a tracking area of the apparatus in response to the request.

According to a twentieth aspect of the invention, there is provided a method, comprising checking if an interface between an apparatus performing the method and a master base station is being set up; informing the master base station on a tracking area of the apparatus when the interface is set up.

According to a twenty-first aspect of the invention, there is provided a method, comprising supervising if a tracking area information of an apparatus performing the method is modified to a new tracking area information; informing a master base station about the new tracking area information.

The method of each of the fifteenth to twenty-first aspects may be a method of tracking area update in dual connectivity.

According to a twenty-second aspect of the invention, there is provided a computer program product comprising a set of instructions which, when executed on an apparatus, is configured to cause the apparatus to carry out the method according to any one of the fifteenth to twenty-first aspects. The computer program product may be embodied as a computer-readable medium or directly loadable into a computer.

According to some embodiments of the invention, at least one of the following advantages may be achieved:
Signaling load is reduced, in particular in case of RRC connection-release for UE in dual connectivity; and
CS fallback to collocated 3G cell is simplified for UE in dual connectivity.

It is to be understood that any of the above modifications can be applied singly or in combination to the respective aspects to which they refer, unless they are explicitly stated as excluding alternatives.

### BRIEF DESCRIPTION OF THE DRAWINGS

Further details, features, objects, and advantages are apparent from the following detailed description of the preferred embodiments of the present invention which is to be taken in conjunction with the appended drawings, wherein

FIG. 1 shows C-plane connectivity of eNBs involved in dual connectivity;

FIG. 2 shows U-plane connectivity of eNBs involved in dual connectivity;

FIG. 3 shows a message exchange according to an embodiment of the invention;

FIG. 4 shows an apparatus according to an embodiment of the invention;

FIG. 5 shows a method according to an embodiment of the invention;

FIG. 6 shows an apparatus according to an embodiment of the invention;

FIG. 7 shows a method according to an embodiment of the invention;

FIG. 8 shows an apparatus according to an embodiment of the invention;

FIG. 9 shows a method according to an embodiment of the invention;

FIG. 10 shows an apparatus according to an embodiment of the invention;

FIG. 11 shows a method according to an embodiment of the invention;

FIG. 12 shows an apparatus according to an embodiment of the invention;

FIG. 13 shows a method according to an embodiment of the invention;

FIG. 14 shows an apparatus according to an embodiment of the invention;

FIG. 15 shows a method according to an embodiment of the invention;

FIG. 16 shows an apparatus according to an embodiment of the invention;

FIG. 17 shows a method according to an embodiment of the invention; and

FIG. 18 shows an apparatus according to an embodiment of the invention.

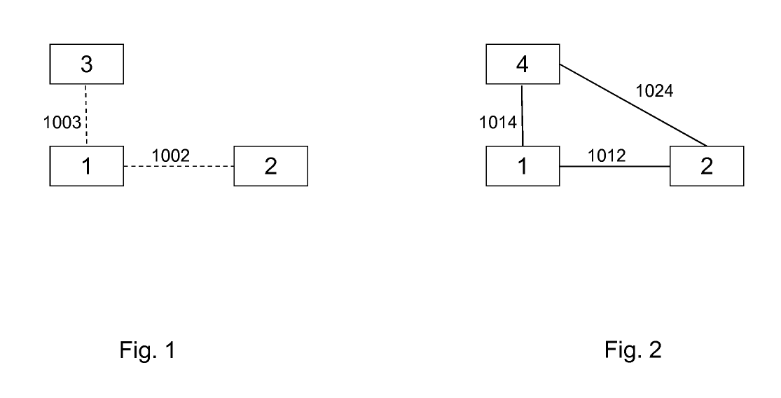

### DETAILED DESCRIPTION OF CERTAIN EMBODIMENTS

Herein below, certain embodiments of the present invention are described in detail with reference to the accompanying drawings, wherein the features of the embodiments can be freely combined with each other unless otherwise described. However, it is to be expressly understood that the description of certain embodiments is given for by way of example only, and that it is by no way intended to be understood as limiting the invention to the disclosed details.

Moreover, it is to be understood that the apparatus is configured to perform the corresponding method, although in some cases only the apparatus or only the method are described.

With the conventional configuration, when a UE moves across macro cells and small cells in idle or connected mode tracking area update will be triggered by the UE and the MME assigns a TA to the UE according to the target cell.

However, as may be shown hereinafter, there may be a problem related to this TA update, when a UE in dual connectivity mode moves from a macro cell to the coverage area of a small cell.

### Idle Mode Mobility Scenario

1. UE triggers tracking area update (TAU) or registration in idle mode from the macro cell. Accordingly, the TA-list provided from the MME will not include tracking area information according to the scheme TA2 for small cells.
2. This allows a UE to trigger a TAU when it enters into a small cell in idle mode. The MME will in this case assign tracking area information according to the scheme TA2 for small cells.

This procedure ensures that, at any point of time, the MME is not required to search/page the UE in tracking areas of both schemes TA1 and TA2.

In order to illustrate the problem in dual connectivity, first a scenario for single connectivity is explained.

### Connected Mode Mobility Scenario for Single Connectivity UE

1. UE successfully handed over to a small cell (target cell),
2. UE is aware of the tracking area according to scheme TA2 and associated with the target cell because it reads the system information of the small cell (target cell).
3. UE sends the uplink NAS message with the TAU request. The eNB of the target cell will include its TA according to scheme TA2 when it sends this NAS message to the MME in a S1 message.
4. MME determines based on the received S1 message that the UE has moved into a cell associated with scheme TA2, and will send TAU information comprising a TA-list according to scheme TA2 for small cells.
5. On release of the RRC connection at the small cell at a later point in time, the UE will select the same cell for camping. Accordingly, the TA in idle mode matches with stored TA and no TAU is needed.

Now, two scenarios 1 and 2 for dual connectivity, which correspond to the above discussed single connectivity scenario, are outlined:

Scenario 1: Mobility of UE Operating in Dual Connectivity from a MeNB Cell to a SeNB Cell

As per the latest 3GPP Release 12 specifications agreements for dual connectivity, the tracking area of the MeNB is the reference for both UE and MME. On release of the RRC connection the UE compares this TA against that of the newly selected cell and decides on a TAU request. In the same way the MME always assigns the TA to UE based on the serving cell, and in case of dual connectivity, MME always assigns the TA information according to the scheme of the macro cell used for data transmission in dual connectivity mode.

With reference to the above UE behaviour, in deployments where MeNB and SeNB use different tracking area schemes, the following sequence will be observed when the UE enters into the coverage area of the SeNB in connected mode followed by release of the RRC connection and the UE selecting the cell of the SeNB for camping in idle mode according to current specifications in LTE:
When the UE enters the coverage area of a cell of the SeNB, the MeNB may add the SeNB cell to the UE based on measurement reports, and then the UE starts operating in dual connectivity mode.
Even though the tracking area of the SeNB is different from the tracking area of the MeNB, both UE and MME will not be aware of the tracking area associated with the SeNB cell. The reason why the UE in dual connectivity mode does not notice the tracking area associated with the SeNB cell is that the UE does not read the system information of its SCell(s) when operating in dual connectivity mode.
When the UE releases the RRC connection, enters into idle mode and selects the cell of the SeNB for camping, the UE notices that this cell is associated with a TA which differs from its previously assigned TA. Therefore the UE will trigger a tracking area update procedure for updating the new location to MME.

### Comparison of UE Operating in Dual Connectivity to UE Operating in Single Connectivity:

A UE operating in single connectivity mode and moving towards a SeNB cell will trigger the tracking area update procedure in connected mode after successful handover of the UE to the SeNB cell. This avoids triggering the tracking area update procedure in idle after the RRC connection has been released. In contrast, in dual connectivity, TAU procedure is triggered by UE only right after the RRC connection has been released.

Scenario 2: Handover from SeNB Cell to MeNB Cell for Enabling Dual Connectivity Operation Upon Connection Establishment

When UE starts connection establishment in a cell of a SeNB, and if the SeNB knows that there is a certain overlap between the coverage areas of its cell and the cell of a MeNB, the SeNB will trigger handover to the MeNB for enabling dual connectivity operation upon connection establishment. In this scenario,
the UE will trigger the tracking area update procedure after successful handover to the MeNB cell,
MeNB will include now SCG and UE starts its dual connectivity.
upon release of the RRC connection, when the UE selects the SeNB cell for camping, the UE will trigger another tracking area update procedure when it notices that the TA associated with the SeNB differs from the TA associated with the macro cell.

Again, in dual connectivity, TAU procedure is triggered by UE right after the RRC connection has been released.

### Impact to Operator and UE

The above scenarios may occur more or less frequently in heterogeneous networks employing dual connectivity operation. In both scenarios a TAU is performed when the UE is no longer in connected mode. Since an RRC connection is to be established if TAU is to be performed for a UE in idle mode, such a TAU results in additional RRC signalling effort for RRC connection-setup and subsequent RRC connection-release messages for enabling the transmission of messages related to the TAU in the mobile network.

Impact to operator: Additional RRC-Connection-Setup procedures at SeNB (for every RRC connection release in the coverage area of a SeNB cell after the UE has been connected to the SeNB via SCG-Addition).

Impact to UE: Additional RRC-Connection-Release signalling (for every RRC connection release in the coverage area of a SeNB cell after the UE has been connected to the SeNB via SCG-Addition).

A main reason for the above described additional signalling for TAU in networks employing dual connectivity operation is that the UE and MME are not aware of the UE entering into new tracking area as part of dual connectivity operation.

According to some embodiments of the invention, compared to a conventional SeNB addition procedure, the SeNB addition procedure is changed such that both, UE and MeNB, are informed about changes of the tracking areas related to macro cells and small cells during dual connectivity operation of a UE.

As outlined hereinabove, an issue for MeNB and SeNB having different tracking areas for a dual connectivity UE is the tracking area update right after release of the RRC connection of UE if the UE camps on the SeNB.

According to some embodiments of the invention, at least one of the following functionalities is provided in order to overcome the issue:
UE is informed about the TAI of the SCG (SCG-TAI) when the RRC-Configuration includes SCG configuration. This will enable UE to know that UE entered into another TA as part of dual connectivity mobility.
MeNB also informs the SCG-TAI to MME on completion of SCG Addition to allow MME to select the SCG-TAI when it receives TAU after SCG Addition (i.e., when SCG is added to the UE such that the UE is in dual connectivity mode by MCG and SCG).
UE compares SCG-TAI with its stored TA-list and decides on triggering TAU based on the comparison, i.e. TAU is triggered if the SCG-TAI is not comprised it the TA-list stored in the UE.

TAI denotes the information of the TA to which the respective eNB (such as the eNB of the SCG) belongs which is stored in the eNB. All cells of a SCG may belong to a same TA. If the cells belong to different TAs, SCG-TAI should comprise all of these TAs.

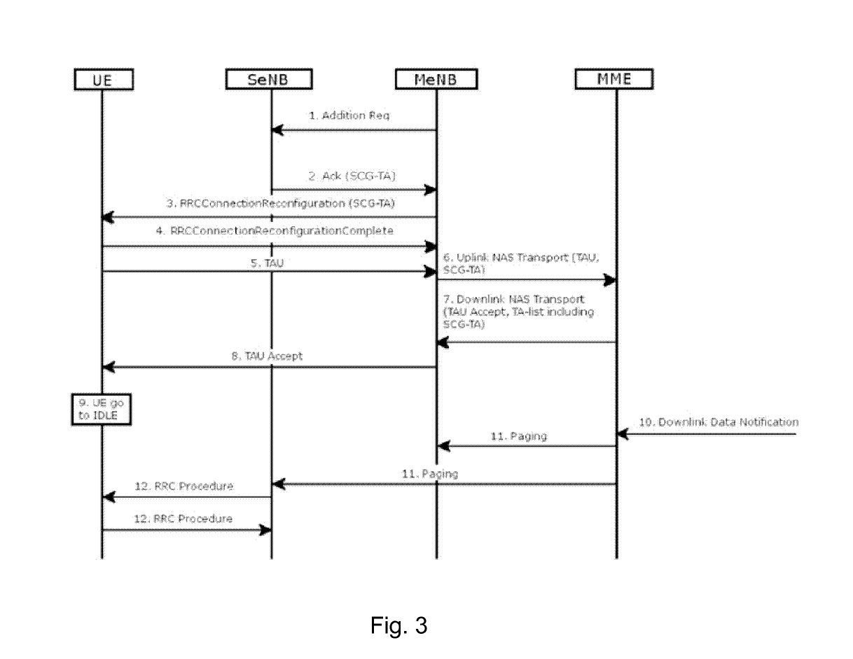

FIG. 3 shows a message flow according to an embodiment of the invention. Some modifications over a conventional message flow are explained hereinafter. Namely, adding SCG-TA (i.e. information on SCG-TA=SCG-TAI) to messages 2, 3, 6, and 7 is not foreseen in a conventional message flow.

By message 1, MeNB issues an Addition request to SeNB in order to add SeNB to UE such that UE may operate in dual connectivity by MeNB providing MCG and SeNB providing SCG.

The Addition request is acknowledged by SeNB by message 2. The acknowledgment comprises SCG-TAI. Thus, MeNB is informed about SCG-TA. By message 3, MeNB informs UE about SCG-TA as part of commonSCell configuration. E.g., as shown in FIG. 3, SCG-TAI is comprised in a RRCConnectionReconfiguration message. By message 4, upon completion of the RRC Connection reconfiguration of message 3, UE sends RRCConnectionReconfigurationComplete to MeNB.

Since message 3 comprises a TAI, UE requests by message 5 TAU. This request is forwarded by MeNB to MME by message 6. The Uplink NAS transport message 6 comprises not only TAU but also SCG-TAI. Thus, MME is informed about SCG-TA which is different from the TA currently stored on the UE. Alternatively, the MeNB may inform the MME about the SCG-TA via the enhanced E-RAB Modification Indication message, or S1 Path Switch Request message, or S1 Handover Request Acknowledge message.

By message 7, in response to message 6, MME issues a downlink NAS Transport message comprising TAU Accept and a TA list which comprises SCG-TAI. Depending on configuration (e.g. by the operator, or pre-configured), there are two options for the TA list:
The TA list comprises only SCG-TAI such that TA of SCG becomes the TA for the UE. Thus, TAU on release of the RRC connection is avoided when the UE is connected to SeNB.
The TA list comprises both SCG-TAI and MCG-TAI (TAI of the MCG belonging to MeNB). Thus, there will not be any TAU on release of RRC connection irrespective of the new cell connection (as long as UE is connected to at least one of MeNB and SeNB).

By message 8, the TA list from MME is forwarded by MeNB to UE in a TAU Accept message. Some embodiments of the invention may not comprise the messages starting with message 8. These messages (in particular messages 10 to 12) are shown to illustrate that methods according to some embodiments of the invention avoid a TAU procedure after UE connected to SeNB in secondary connectivity goes into idle mode.

Messages 10 to 12 correspond to conventional paging messages. I.e., as shown by box 9, UE may go into idle mode. When downlink data notification arrives at MME (message 10), MME pages MeNB and SeNB (messages 11) because both are in the TA list associated to UE (here, the second option of message 7 is assumed; if the first option of message 7 was performed, MME pages only SeNB).

Since UE camps on SeNB, RRC procedure (in particular: RRCConnectionSetUp) is performed between SeNB and UE (indicated by the two arrows between UE and SeNB for message 12: RRC procedure).

As may be seen from FIG. 3, there is no TAU when UE releases RRC connection (goes into idle mode, see box 9) while being connected to SeNB.

There are several optional modifications of this message flow, which still may belong to embodiments of the invention. These options may be applied singly, or some or all of them may be combined.

For example, as one option, message 2 may not comprise SCG-TAI if MeNB is informed otherwise on SCG-TAI. For example, MeNB may be informed on SCG-TA at setup procedure of the X2 interface between MeNB and SeNB, or SCG-TA may be pre-configured in MeNB. Thus, a message according to some embodiments of the invention may not comprise messages 1 and 2.

As another option, before message 3, MeNB may compare SCG-TAI with its own TAI. If SCG-TAI is comprised in its own TAI, message 3 is inhibited (RRCConnectionReconfiguration command comprising SCG-TAI) is not sent) and the method stops. Thus, signaling effort may be reduced even more because there is no need to update the TA list on UE.

Correspondingly, as another option, after receipt of SCG-TAI by message 3, UE may compare SCG-TAI with its TA list. If the TA list comprises SCG-TAI, there is no need for TAU, such that message 5 (TAU) is inhibited and the method stops. Thus, signaling effort may be reduced even more.

As still another option, UE upon receipt of SCG-TAI by message 3 may update its TA list internally, without a TAU procedure. Correspondingly, MeNB may inform MME on SCG-TA for the UE without being triggered by a TAU request of message 5. For example, MeNB may send a dedicated NAS message to MME for this purpose. As a result, both UE and MME have SCG-TA associated to the UE. Thus, a method according to some embodiments of the invention may not comprise messages 5, 7, and 8, and message 6 may be different from the uplink NAS transport message shown in FIG. 3.

Also in some embodiments of this option, one or both of UE and MeNB may perform their respective action only after they have checked that SCG-TAI is not comprised in their respective TA list/TAI.

As still another option, UE may receive SCG-TAI by monitoring SeNB's SIB (rather: SIB of a cell of SCG). Thus, some embodiments of the invention may not comprise messages 3 and 4 of FIG. 3.

As another option, SeNB may inform MeNB if its SCG-TAI is modified to a new SCG-TAI, e.g. by O&M. In this case, MeNB may perform the method of FIG. 3 (or one or more of the other options described for FIG. 3) starting at message 3. In some cases, MeNB may check, after receipt of the new SCG-TAI, if the new SCG-TAI is the same as the previous SCG-TAI stored for the SeNB. In these cases, MeNB informs both the UE and the MME on the new SCG-TAI only if it is not the same as the previous SCG-TAI. Furthermore, in some embodiments of the invention, MeNB may identify UEs connected to MeNB and SeNB in dual connectivity after receipt of the new SCG-TAI and inform only the UEs connected in dual connectivity on the new SCG-TAI.

Thus, a message according to some embodiments of the invention may not comprise messages 1 and 2 shown in FIG. 3.

Some embodiments of the invention may comprise a CS-Fallback scenario with multimode SeNB:

MME may use the SCG-TAI to assign LA (Location Area) corresponding to SCG-TAI towards UE as part of TAU. For this, it may be checked if the TAI-LAC (Location Area Code) mapping table has a different value for the SCG-TA than for MCG-TA. Whether or not such a check takes places, may depend on the implementation or a configuration set by the operator. Also, whether LA corresponding to SCG-TAI has prevalence over LA corresponding to MCG-TAI or vice versa, may depend on the implementation or a configuration set by the operator. This mapping table comprises a mapping of TA to a LAC of a 3G-cell covering substantially the same area. E.g. a NodeB of such a 3G-cell may be collocated with the corresponding eNB.

With this enhancement, when a CS-Fallback is triggered for a dual connectivity UE towards the 3G-cell substantially corresponding to the SeNB with respect to coverage area (“collocated cell”), the location area update will be avoided as the UE is assigned with the LA of the collocated cell already.

According to some embodiments of the invention, a method corresponding to that of FIG. 3 and its options may be performed if a UE changes from one SCG to a new SCG with a different TA. That is, in these embodiments, the method is triggered at SCG change instead of at SCG addition. In this case, SCG-TA in FIG. 3 is SCG-TA of the new SCG. In some embodiments of the invention, the method may be triggered at both SCG addition and SCG change.

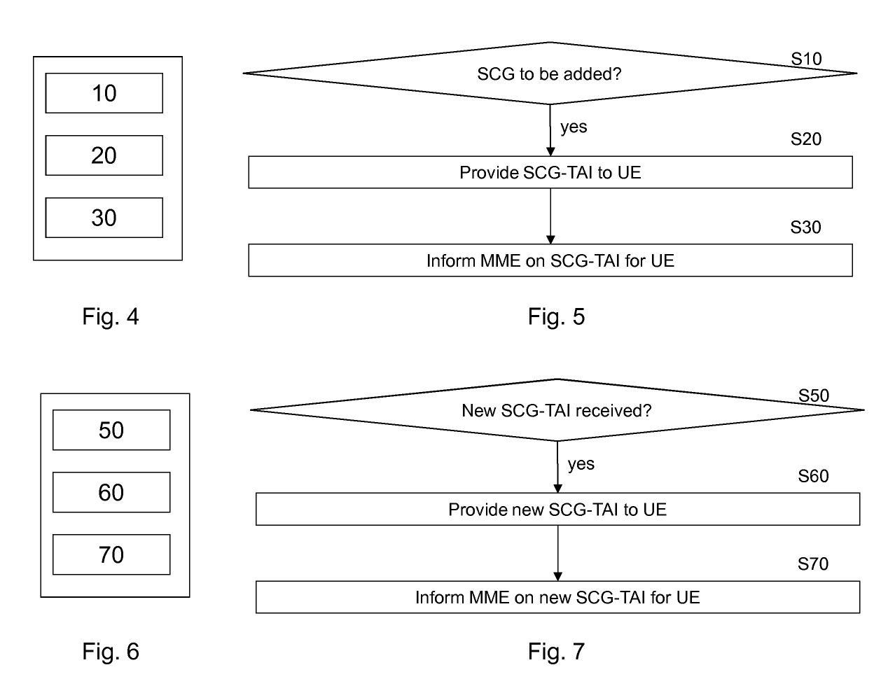

FIG. 4 shows an apparatus according to an embodiment of the invention. The apparatus may be a base station such as an eNodeB or NodeB, or an element thereof. It may function as MeNB. FIG. 5 shows a method according to an embodiment of the invention. The apparatus according to FIG. 4 may perform the method of FIG. 5 but is not limited to this method. The method of FIG. 5 may be performed by the apparatus of FIG. 4 but is not limited to being performed by this apparatus.

The apparatus comprises checking means 10, providing means 20, and informing means 30.

The checking means 10 checks if a terminal connected to the apparatus is additionally to be connected to a secondary base station (such as a SeNB) in a dual connectivity (S10). More precisely, the checking means checks if the terminal is additionally to be connected to a SCG of the SeNB. The secondary base station or SCG may be added because the UE goes into dual connectivity, or the secondary base station or SCG may be added in order to replace another secondary base station to which the UE was connected.

If the terminal is to be connected in the dual connectivity to the secondary base station (“yes” in S10), the providing means 20 provides a secondary tracking area information of the secondary base station or SCG to the terminal (S20). For example, the secondary tracking area information may be received from the secondary base station, e.g. in response to an Addition request or at setup of an interface between the apparatus and the secondary base station, or it may be pre-configured (e.g. by O&M) in the apparatus.

The informing means 30 informs a management entity (such as a MME) about the secondary tracking area information related to the terminal (S30). In particular, in some embodiments, the informing means 30 may inform the management entity only after receipt of a tracking area update request from the terminal after the terminal is provided with the secondary tracking area information. The sequence of S20 and S30 may be interchanged, or S20 and S30 may be performed simultaneously.

FIG. 6 shows an apparatus according to an embodiment of the invention. The apparatus may be a base station such as an eNodeB or NodeB, or an element thereof. It may function as MeNB. FIG. 7 shows a method according to an embodiment of the invention. The apparatus according to FIG. 6 may perform the method of FIG. 7 but is not limited to this method. The method of FIG. 7 may be performed by the apparatus of FIG. 6 but is not limited to being performed by this apparatus.

The apparatus comprises checking means 50, providing means 70, and informing means 80.

The checking means 50 checks if an information on a secondary tracking area information of a secondary base station is received (S50). In addition, according to some embodiments of the invention, it may check if the received secondary tracking information is the same as the secondary tracking information stored before the receiving. If they are the same, the method may stop after S50.

The providing means 60 provides, if the secondary tracking area information is received, the secondary tracking area information to a terminal (S60) such as a UE. In some embodiments of the invention, an identifying means identifies a terminal connected to the apparatus and to the secondary base station in dual connectivity, and the secondary tracking information is provided to the identified terminals only.

The informing means 70 informs a management entity (such as a MME) about the secondary tracking area information related to the terminal (S70).

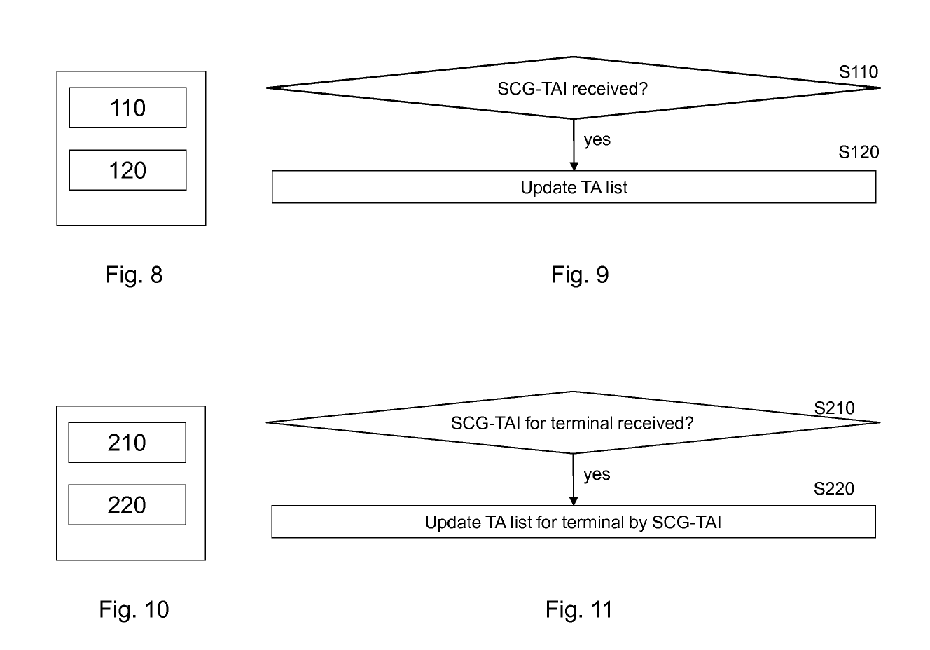

FIG. 8 shows an apparatus according to an embodiment of the invention. The apparatus may be a terminal such as a UE, or an element thereof. FIG. 9 shows a method according to an embodiment of the invention. The apparatus according to FIG. 8 may perform the method of FIG. 9 but is not limited to this method. The method of FIG. 9 may be performed by the apparatus of FIG. 8 but is not limited to being performed by this apparatus.

The apparatus comprises monitoring means 110 and updating means 120.

The monitoring means 110 monitors if a secondary tracking area information of a secondary cell group is received (S110). The apparatus is connected in dual connectivity to a master cell group and the secondary cell group of a secondary base station. For example, the secondary tracking area information may be comprised in a reconfiguration message related to setting up the dual connectivity of the apparatus to the master base station and the secondary base station. As another example, the secondary tracking area may be included in SIB of the secondary base station which is monitored by the apparatus.

If the secondary tracking area information is received (“yes” in S110), the updating means 120 updates a tracking area list stored in the apparatus by the secondary tracking area information (S120).

FIG. 10 shows an apparatus according to an embodiment of the invention. The apparatus may be a management entity such as a MME, or an element thereof. FIG. 11 shows a method according to an embodiment of the invention. The apparatus according to FIG. 10 may perform the method of FIG. 11 but is not limited to this method. The method of FIG. 11 may be performed by the apparatus of FIG. 10 but is not limited to being performed by this apparatus.

The apparatus comprises monitoring means 210 and updating means 220.

The monitoring means 210 monitors if a secondary tracking area information is received for a terminal (S210). The secondary tracking area information may be SCG-TAI of a SCG of a SeNB.

If the information is received (“yes” in S210), the updating means 220 updates a tracking area list for the terminal by the secondary tracking area information, wherein the tracking area list is stored by the apparatus (S220). That is, the updating means 220 may additionally include the secondary tracking area information in the tracking area list, or the updating means 220 may replace some or all parts of the tracking area list by the secondary tracking area information.

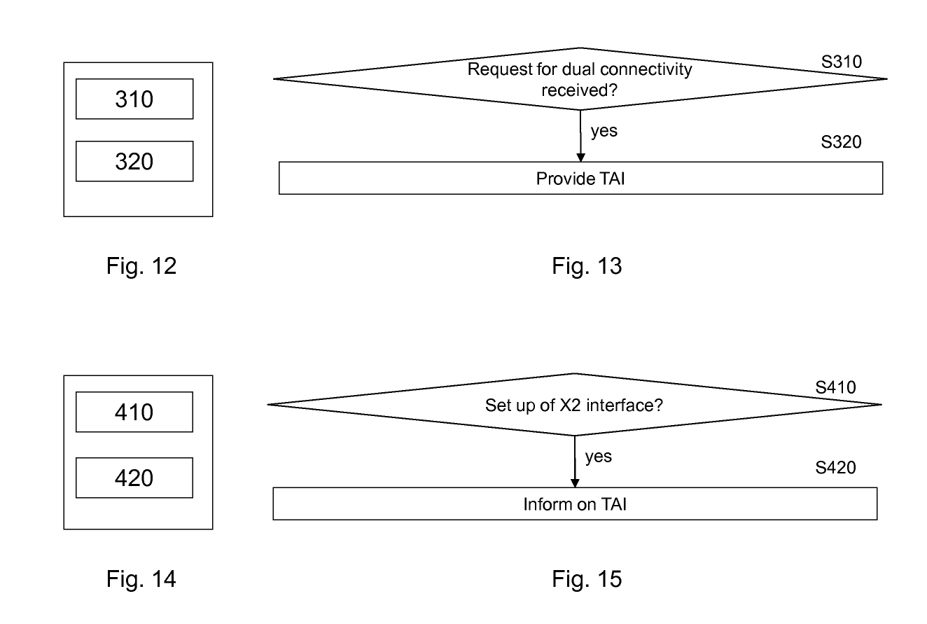

FIG. 12 shows an apparatus according to an embodiment of the invention. The apparatus may be a base station such as an eNodeB or NodeB, or an element thereof. The apparatus may function as a SeNB. FIG. 13 shows a method according to an embodiment of the invention. The apparatus according to FIG. 12 may perform the method of FIG. 13 but is not limited to this method. The method of FIG. 13 may be performed by the apparatus of FIG. 12 but is not limited to being performed by this apparatus.

The apparatus comprises monitoring means 310 and providing means 320.

The monitoring means 310 monitors if a request to add the apparatus for dual connectivity of a terminal with a master base station and the apparatus is received from the master base station (S310). If the request is received (“yes” in S310), the providing means 320 provides a secondary tracking area information indicating a tracking area of the apparatus in response to the request (S320). I.e., the secondary tracking area information is provided to the master base station.

FIG. 14 shows an apparatus according to an embodiment of the invention. The apparatus may be a base station such as an eNodeB or NodeB, or an element thereof. The apparatus may function as a SeNB. FIG. 15 shows a method according to an embodiment of the invention. The apparatus according to FIG. 14 may perform the method of FIG. 15 but is not limited to this method. The method of FIG. 15 may be performed by the apparatus of FIG. 14 but is not limited to being performed by this apparatus.

The apparatus comprises checking means 410 and informing means 420.

The checking means 410 checks if an interface between the apparatus and a master base station is being set up (S410). The interface may be an X2 interface.

If the interface is being set up (“yes” in S410), the informing means 420 informs the master base station on a tracking area of the apparatus (S410).

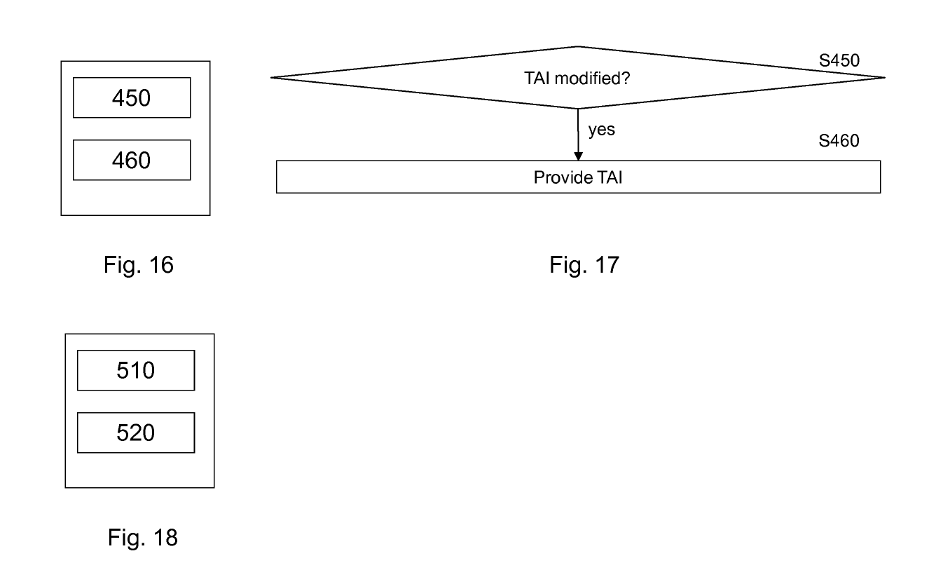

FIG. 16 shows an apparatus according to an embodiment of the invention. The apparatus may be a base station such as an eNodeB or NodeB, or an element thereof. The apparatus may function as a SeNB. FIG. 17 shows a method according to an embodiment of the invention. The apparatus according to FIG. 16 may perform the method of FIG. 17 but is not limited to this method. The method of FIG. 17 may be performed by the apparatus of FIG. 16 but is not limited to being performed by this apparatus.

The apparatus comprises supervising means 450 and informing means 460.

The supervising means 450 supervises if a tracking area information of the apparatus is modified to a new tracking area information (S450). The racking area information may be a SCG-TAI of a SCG related to the apparatus.

If the tracking area information is modified (S450=“yes”), the informing means 460 informs a master base station about the new tracking area information (S460).

FIG. 18 shows an apparatus according to an embodiment of the invention. The apparatus comprises at least one processor 510, at least one memory 520 including computer program code, and the at least one processor, with the at least one memory and the computer program code, being arranged to cause the apparatus to at least perform at least one of the methods according to FIGS. 5, 7, 9, 11, 13, 15, and 17.

Embodiments of the invention may be employed in a 3GPP network such as a LTE or an LTE-A network. They may be employed also in other mobile networks enabling dual connectivity such as CDMA, EDGE, UMTS, Wi-Fi networks, etc.

A terminal may be any device capable to be connected to the radio access network, such as a UE, a laptop, a tablet, a smartphone, a communicator, a machine, a robot, a wearable, etc.

If not otherwise stated, one piece of information may be transmitted in one or plural messages from one entity to another entity. Each of these messages may comprise further (different) pieces of information.

Names of network elements, protocols, and methods are based on current standards. In other versions or other technologies, the names of these network elements and/or protocols and/or methods may be different, as long as they provide a corresponding functionality. The functionality may be integral to one or few of the network elements or it may be shared or distributed among the network elements, or their cloud.

If not otherwise stated or otherwise made clear from the context, the statement that two entities are different means that they perform different functions. It does not necessarily mean that they are based on different hardware. That is, each of the entities described in the present description may be based on a different hardware, or some or all of the entities may be based on the same hardware. It does not necessarily mean that they are based on different software. That is, each of the entities described in the present description may be based on different software, or some or all of the entities may be based on the same software.

According to the above description, it should thus be apparent that exemplary embodiments of the present invention provide, for example a base station such as a NodeB or eNodeB such as a MeNB or a SeNB, or a component thereof, an apparatus embodying the same, a method for controlling and/or operating the same, and computer program(s) controlling and/or operating the same as well as mediums carrying such computer program(s) and forming computer program product(s). Furthermore, exemplary embodiments of the present invention provide, for example a management entity such as a MME, or a component thereof, an apparatus embodying the same, a method for controlling and/or operating the same, and computer program(s) controlling and/or operating the same as well as mediums carrying such computer program(s) and forming computer program product(s). Furthermore, exemplary embodiments of the present invention provide, for example a terminal such as a UE, or a component thereof, an apparatus embodying the same, a method for controlling and/or operating the same, and computer program(s) controlling and/or operating the same as well as mediums carrying such computer program(s) and forming computer program product(s).

Implementations of any of the above described blocks, apparatuses, systems, techniques or methods include, as non limiting examples, implementations as hardware, software, firmware, special purpose circuits or logic, general purpose hardware or controller or other computing devices, or some combination thereof.

It is to be understood that what is described above is what is presently considered the preferred embodiments of the present invention. However, it should be noted that the description of the preferred embodiments is given by way of example only and that various modifications may be made without departing from the scope of the invention as defined by the appended claims.

1.-36. (canceled)

37. An apparatus, comprising:
at least one processor;
and at least one memory including computer program code;
the at least one memory and the computer program code configured to, with the at least one processor, cause the apparatus at least to:
check if a terminal connected to the apparatus is additionally to be connected to a secondary base station in a dual connectivity;
provide, if the terminal is to be connected to the secondary base station in the dual connectivity, a secondary tracking area information of the secondary base station to the terminal; and
inform a management entity about the secondary tracking area information related to the terminal.

38. The apparatus according to claim 37, wherein the at least one memory and the computer program code are further configured to, with the at least one processor, cause the apparatus at least to:
monitor if a tracking area update request is received from the terminal after the secondary tracking area information was provided to the terminal; and
inhibit from informing the management entity if the tracking area update request is not received.

39. The apparatus according to claim 37, wherein the at least one memory and the computer program code are further configured to, with the at least one processor, cause the apparatus at least to:
compare the secondary tracking area information with a master tracking area of the apparatus; and
inhibit from providing the secondary tracking area information if the master tracking area information comprises the secondary tracking area information.

40. The apparatus according to claim 37, wherein
the secondary tracking area information is received from the secondary base station in response to an addition request for the terminal, or during a setup procedure of an interface to the secondary base station.

41. The apparatus according to claim 37, wherein the apparatus is comprised in a macro base station.

42. An apparatus, comprising:
at least one processor;
and at least one memory including computer program code;
the at least one memory and the computer program code configured to, with the at least one processor, cause the apparatus at least to:
monitor if a secondary tracking area information of a secondary base station is received, wherein the apparatus is connected in a dual connectivity to a master base station and the secondary base station; and
update, if the secondary tracking information is received, a tracking area list stored in the apparatus by the secondary tracking area information.

43. The apparatus according to claim 42, wherein the at least one memory and the computer program code are further configured to, with the at least one processor, cause the apparatus at least to:
request a tracking area update if the secondary tracking area information is received; and
inhibit from updating the tracking area list until a response to the tracking area update request is received, wherein the response comprises the secondary tracking area information.

44. The apparatus according to claim 42, the apparatus is a user equipment or user terminal.

45. An apparatus, comprising:
at least one processor;
and at least one memory including computer program code;
the at least one memory and the computer program code configured to, with the at least one processor, cause the apparatus at least to:
monitor if an information is received from a master base station on a secondary tracking area information related to a terminal; and
update, if the information is received, a tracking area list for the terminal stored by the apparatus by including the secondary tracking area information.

46. The apparatus according to claim 45,
wherein the information is comprised in an uplink message informing additionally on a tracking area update request of the terminal; and
wherein the at least one memory and the computer program code are further configured to, with the at least one processor, cause the apparatus at least to respond to the uplink message by a downlink message comprising the updated tracking area list.

47. The apparatus according to claim 45, wherein
the updated tracking area list comprises the secondary tracking area information only, or wherein
the updated tracking area list comprises the secondary tracking area information in addition to tracking area information comprised by the tracking area list before the updating.

48. The apparatus according to claim 45, wherein
the updated tracking area list comprises the secondary tracking area information indicating a tracking area of a secondary base station, and a master tracking area information indicating a tracking area of a master base station.

49. The apparatus according to claim 45, wherein the at least one memory and the computer program code are further configured to, with the at least one processor, cause the apparatus at least to:
identify, based on the secondary tracking area information, a secondary local area code, wherein the secondary local area code is related to a location of the secondary base station; and
provide, if the information about the tracking area update request is received, the secondary local area code to the master base station.

50. The apparatus according to claim 49, wherein the at least one memory and the computer program code are further configured to, with the at least one processor, cause the apparatus at least to:
compare the secondary local area code with a master local area code related to a location of the master base station; and
inhibit from providing the secondary local area code if the secondary local area code and the master local area code are the same.

51. The apparatus according to claim 45, wherein
the information is comprised in an uplink message comprising at least one of a radio access bearer modification request, a path switch request, and a handover request acknowledge.

52. The apparatus according to claim 45, wherein the apparatus is comprised in a mobility management entity.
